(19) United States
(12) Patent Application Publication
(10) Pub. No.: US 2018/0197218 A1
(43) Pub. Date: Jul. 12, 2018

(54) SYSTEM AND METHOD FOR OBJECT DETECTION IN RETAIL ENVIRONMENT

(71) Applicant: Verizon Patent and Licensing Inc., Arlington, VA (US)

(72) Inventors: Saravanan Mallesan, Fairfax, VA (US); Gina L. Otts, Flower Mound, TX (US); Jean M. McManus, Bernardsville, NJ (US); Dante J. Pacella, Charles Town, WV (US); Christopher N. DelRegno, Rowlett, TX (US); Matthew W. Turlington, Richardson, TX (US); Ashish Sardesai, Ashburn, VA (US)

(21) Appl. No.: 15/855,199

(22) Filed: Dec. 27, 2017

Related U.S. Application Data
(60) Provisional application No. 62/445,401, filed on Jan. 12, 2017.

(51) Int. Cl. G06Q 30/06; G06K 17/00; G06Q 20/20

(52) U.S. Cl. CPC G06Q 30/0613; G06K 17/0022; G06K 7/10762; G06Q 20/202; G06Q 20/208

(57) ABSTRACT

A smart shopping container and supporting network perform object recognition for items in a retail establishment. A network device receives a signal from a user device to associate a portable container with a retail application being executing on the user device. The network device receives, from the container, images of a holding area of the container. The images are captured by different cameras at different positions relative to the holding area and are captured proximate in time to detecting an activity that places an object from the retail establishment into the holding area. The network device generates a scene of the holding area constructed of multiple images from the different cameras and identifies the object as a retail item using the scene. The network device associates the retail item with a stock-keeping unit (SKU) and creates a product list that includes an item description for the object associated with the SKU.

### CROSS-REFERENCE TO RELATED APPLICATIONS

The application claims priority from U.S. Provisional Patent Application No. 62/445,401, filed Jan. 12, 2017, the contents of which are hereby incorporated herein by reference in its entirety.

### BACKGROUND

One aspect of the traditional retail experience includes shoppers going through a checkout line to purchase selected goods retrieved from a retailer's shelves. Shoppers typically place items they intend to purchase in a cart or a basket and unload the cart at the checkout line to permit scanning of the items. After the items are scanned, a cashier may collect payment and place the items in a bag and/or return the items to the cart or the basket.

### BRIEF DESCRIPTION OF THE DRAWINGS

FIG. 1 is a schematic illustrating concepts described herein;

FIG. 2 is a diagram that depicts an exemplary network environment in which systems and methods described herein may be implemented;

FIG. 3 is a diagram illustrating exemplary components that may be included in one or more of the devices shown in FIG. 1;

FIG. 4 is a block diagram illustrating exemplary logical aspects of a smart shopping cart of FIG. 1;

FIG. 5 is a block diagram illustrating exemplary logical aspects of a user device of FIG. 1;

FIG. 6A is a block diagram illustrating exemplary logical aspects of an application platform of FIG. 2;

FIG. 6B is a block diagram illustrating exemplary logical aspects of a cart platform of FIG. 2;

FIG. 7 is a block diagram illustrating exemplary logical aspects of a retailer network of FIG. 1; and

FIGS. 8 and 9 are flow diagrams illustrating an exemplary process for detecting objects in a retail environment, according to an implementation described herein.

### DETAILED DESCRIPTION OF THE PREFERRED EMBODIMENTS

The following detailed description refers to the accompanying drawings. The same reference numbers in different drawings may identify the same or similar elements.

Retailers and customers alike have long sensed a need to simplify and expedite the conventional retail checkout process. The ability to electronically detect and track objects as they are placed into a shopper's cart or basket can provide opportunities for alternatives to the conventional checkout procedures. Electronic tags (e.g., RFID tags) and short range wireless communications (e.g., NFC) are some technologies that enable object tracking. But factors such as packaging costs and small sizes of some retail items prevent use of these technologies. In other instances, barcode scanning by the shopper has been used to register objects as they are selected. However, barcode scanning requires additional effort by the shopper and may still require some type of checkout procedure, as some selected items may go un-scanned (intentionally or unintentionally). To be effective, a retail object detection and tracking system must be able to (1) accurately detect objects selected by a shopper for purchase, (2) minimize the possibility of undetected items, and (3) avoid changes to conventional product packaging.

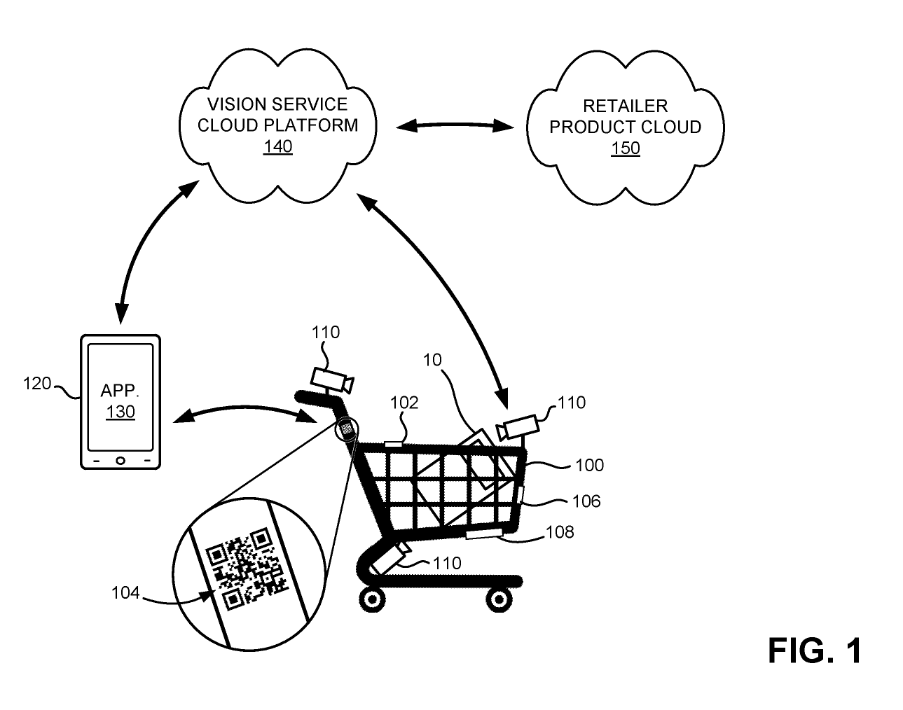

FIG. 1 provides a schematic illustrating concepts described herein. A smart shopping cart 100 may be equipped with sensors 102 (e.g., motion sensors, weight sensors, etc.) to detect placement of objects 10 into (or removal of objects from) cart 100. Cameras 110 integral with cart 100 may collect images of objects placed into cart 100. Cart 100 may also be equipped with a cart identifier 104, such as a barcode, chip, or other device to allow cart 100 to be associated with a user device 120. In addition, cart 100 may be equipped with a beacon receiver 106 or other in-store location technology to provide information on location of products near cart 100. Cart 100 may also be equipped with a computer 108 to receive sensor information from sensors 102, location information from beacon receiver 106, and images from cameras 110 and communicate with vision service cloud platform 140. User device 120 (e.g., a smart phone) may be configured with an application associated with a particular retailer (referred to herein as a “retail application”) that can detect cart identifier 104 and associate a user with cart 100 (and any objects placed therein).

Both cart 100 and user device 120 are configured to communicate with a vision service cloud platform 140. The vision service cloud platform 140 uses information from cameras 110 to identify objects in cart 100 and populate a product list (e.g., a dynamic list of items in cart 100) for the retail application on user device 120. Vision service cloud platform 140 may also communicate with a retailer product cloud 150. Retailer product cloud 150 may provide product images, in-store product locations, stock keeping unit (SKU) numbers, and other information used by vision service cloud platform 140 to identify and track objects in cart 100.

As described further herein, a shopper at a retail establishment may use user device 120 to associate cart 100 with a user's retail application. When activity (e.g., object 10 placement or removal) is detected in the cart via sensors 102, cameras 110 may collect images of the inside (or storage areas) of cart 100. Cart 100 (e.g., computer 108) may send the images (and, optionally, in-store location data obtained by beacon receiver 106) to vision service cloud platform 140. Vision service cloud platform 140 may stitch together images/views from multiple camera 110 angles to construct a complete view of the cart contents and identify objects in cart 100. Object identification may be performed using visual identifications, and objects may be associated with an SKU of the product for use during an eventual automated payment.

Although FIG. 1 and other descriptions herein refer primarily to a smart shopping cart 100, in other embodiments, cart 100 may take the form of a basket, hand truck, reusable shopping bag, bin, box, etc., that can hold physical items selected by a customer for purchase. Thus, cart 100 may also be referred to herein as a portable shopping container.

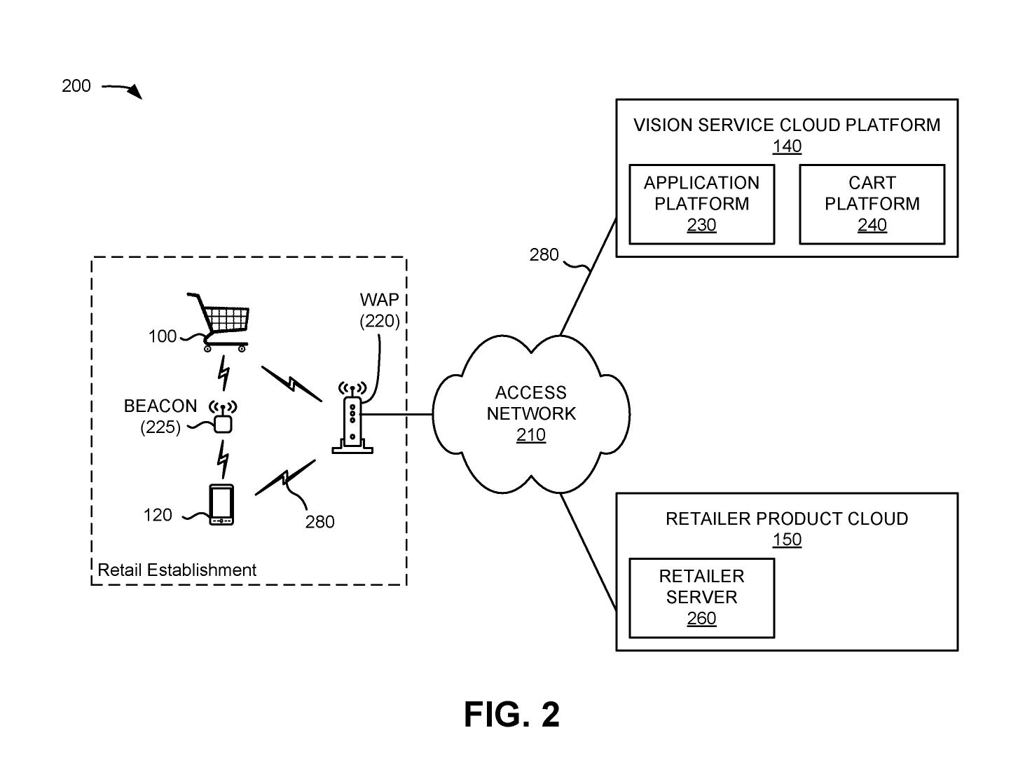

FIG. 2 is a diagram that depicts an exemplary network environment 200 in which systems and methods described herein may be implemented. As illustrated, environment 200 may include cart 100, user device 120, vision service cloud platform 140, retailer product cloud 150, an access network 210, a wireless access point 220, and a beacon 225.

As further illustrated, environment 200 includes communicative links 280 between the network elements and networks (although only two are referenced in FIG. 2). A network element may transmit and receive data via link 280. Environment 100 may be implemented to include wireless and/or wired (e.g., electrical, optical, etc.) links 280. A communicative connection between network elements may be direct or indirect. For example, an indirect communicative connection may involve an intermediary device or network element, and/or an intermediary network not illustrated in FIG. 2. Additionally, the number, the type (e.g., wired, wireless, etc.), and the arrangement of links 280 illustrated in environment 200 are exemplary.

A network element may be implemented according to a centralized computing architecture, a distributed computing architecture, or a cloud computing architecture (e.g., an elastic cloud, a private cloud, a public cloud, etc.). Additionally, a network element may be implemented according to one or multiple network architectures (e.g., a client device, a server device, a peer device, a proxy device, and/or a cloud device).

The number of network elements, the number of networks, and the arrangement in environment 200 are exemplary. According to other embodiments, environment 200 may include additional network elements, fewer network elements, and/or differently arranged network elements, than those illustrated in FIG. 2. For example, there may be multiple carts 100, user devices 120, wireless access points 220, and beacons 225 within each retail establishment. Furthermore, there may be multiple retail establishments, access networks 210, vision service cloud platforms 140, and retailer product clouds 150. Additionally, or alternatively, according to other embodiments, multiple network elements may be implemented on a single device, and conversely, a network element may be implemented on multiple devices. In other embodiments, one network in environment 200 may be combined with another network.

Smart shopping cart 100 may be associated with a user (e.g., via a retailer application on user device 120), may obtain images of objects placed into (or removed from) the storage area of cart 100, may monitor a location of cart 100, and may communicate with vision service cloud platform 140 via access network 210. As described above in connection with FIG. 1, cart 100 may include sensors 102, cameras 110, cart identifier 104, and logic to perform functions described further herein. In another implementation, cart 100 may include a docking station or mounting station for user device 120. For example, cart 100 may include a universal clip, bracket, etc., to secure user device 120 to cart 100.

User device 120 may be implemented as a mobile or a portable wireless device. For example, user device 120 may include a smart phone, a personal digital assistant (PDA) (e.g., that can include a radiotelephone, a pager, Internet/intranet access, etc.), a wireless telephone, a cellular telephone, a portable gaming system, a global positioning system, a tablet computer, a wearable device (e.g., a smart watch), or other types of computation or communication devices. In an exemplary implementation, user device 120 may include any device that is capable of communicating over access network 210. User device 120 may operate according to one or more wireless communication standards such as broadband cellular standards (e.g., Long-Term Evolution (LTE) network, wideband code division multiple access (WCDMA), etc.), local wireless standards (e.g., Wi-Fi®, Bluetooth®, near-field communications (NFC), etc.), and/or other communications standards (e.g., LTE-Advanced, a future generation wireless network (e.g., Fifth Generation (5G)), etc.). In some implementations, user device 120 may be equipped with a location determining system (e.g., a Global Positioning System (GPS) interface), a camera, a speaker, a microphone, a touch screen, and other features.

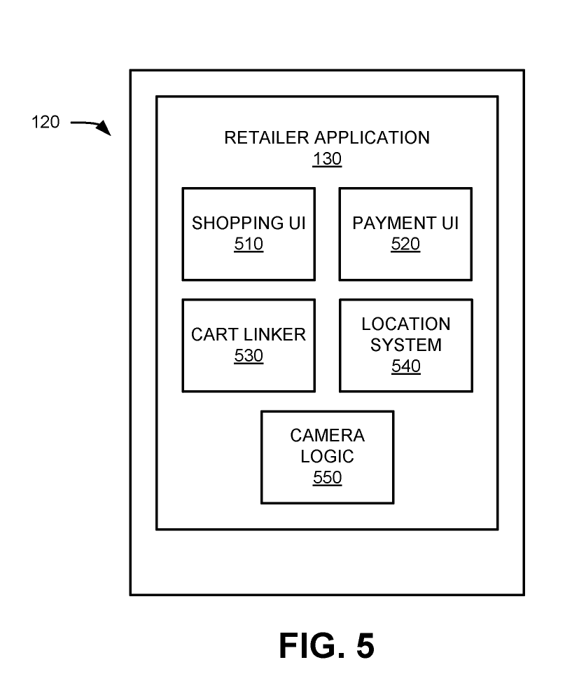

In one implementation, user device 120 may store one or more applications (or “apps”) dedicated to a particular retailer or brand (referred to herein as “retail application 130”). For example, user device 120 may include a separate retailer app 130 for a department store chain, a supermarket chain, a clothing store, electronics store, hardware store, etc. In other implementations, user device 120 may include a retailer app 130 for a brand-specific store (e.g., a clothing brand, a shoe brand, a housewares brand, etc.). Retailer app 130 may facilitate association of a user with cart 100, provide a user interface for object identification questions, enable suggestions for the user, and link to payment systems for automatic payments. According to another implementation, retailer application 130 may use the camera from user device 110 as a substitute for or supplement to cameras 110. For example, when mounted on a docking station of cart 100, retail app 130 may cause user device 120 to collect and send images of the holding area of cart 100. Retailer app 130 is described further herein in connection with, for example, FIG. 5.

Access network 210 may include a network that connects cart 100, user devices 120, and/or wireless access point 220 to vision service cloud platform 140. Access network 210 may also connect vision service cloud platform 140 to retailer product cloud 150. For example, access network 210 may include a communications network, a data network, a local area network (LAN), a wide area network (WAN), a metropolitan area network (MAN), a wireless network, an optical fiber (or fiber optic) network, or a combination of these or other networks. In addition or alternatively, access network 210 may be included in a radio network capable of supporting wireless communications to/from one or more devices in network environment 200, and the radio network may include, for example, an LTE network or a network implemented in accordance with other wireless network standards.

Wireless access point 220 may be configured to enable cart 100, user device 120, and other devices to communicate with access network 210. For example, wireless access point 220 may be configured to use IEEE 802.11 standards for implementing a wireless LAN. In one implementation, wireless access point 220 may provide a periodic signal to announce its presence and name (e.g., a service set identifier (SSID)) to carts 100 and user devices 120.

Beacon 225 may include a simple beacon or a smart beacon that transmits a wireless signal that can be detected by smart carts 100 and/or user devices 120. The beacon 225 signal may cover a relatively small geographical area and may use a unique identifier (e.g., a Bluetooth® identifier signal, a Bluetooth® low energy (BTLE) identifier signal, an iBeacon® identifier signal, etc.) to enable smart cart 100 or user device 120 to associate beacon 225 with a particular location within a retail establishment (e.g., a particular store aisle, a department, a checkout area, etc.). Thus, a retail establishment may include numerous beacons from which an in-store location may be generally determined.

Vision service cloud platform 140 may include one or more computation, communication, and/or network devices to facilitate object identification of items placed in cart 100 and to coordinate shopping and payment services with retailer application 130. Vision service cloud platform 140 may include an application platform 230 and a cart platform 240.

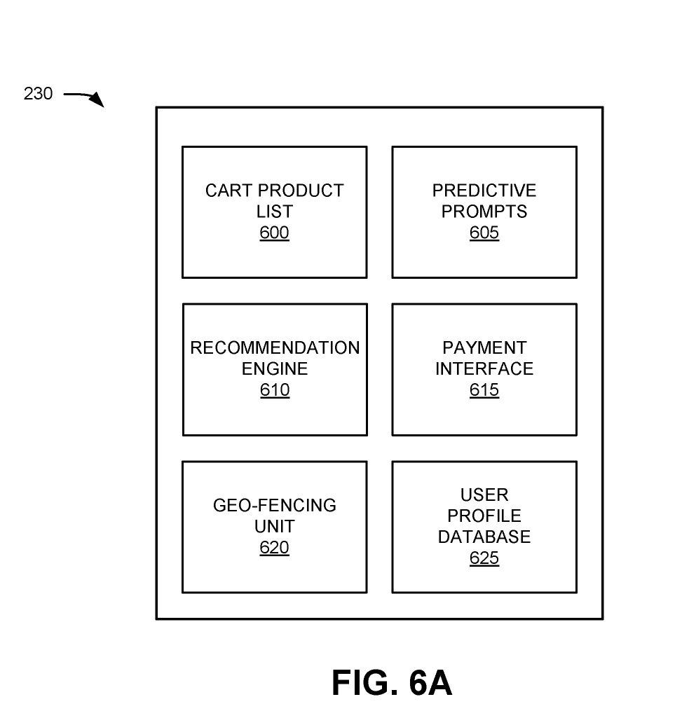

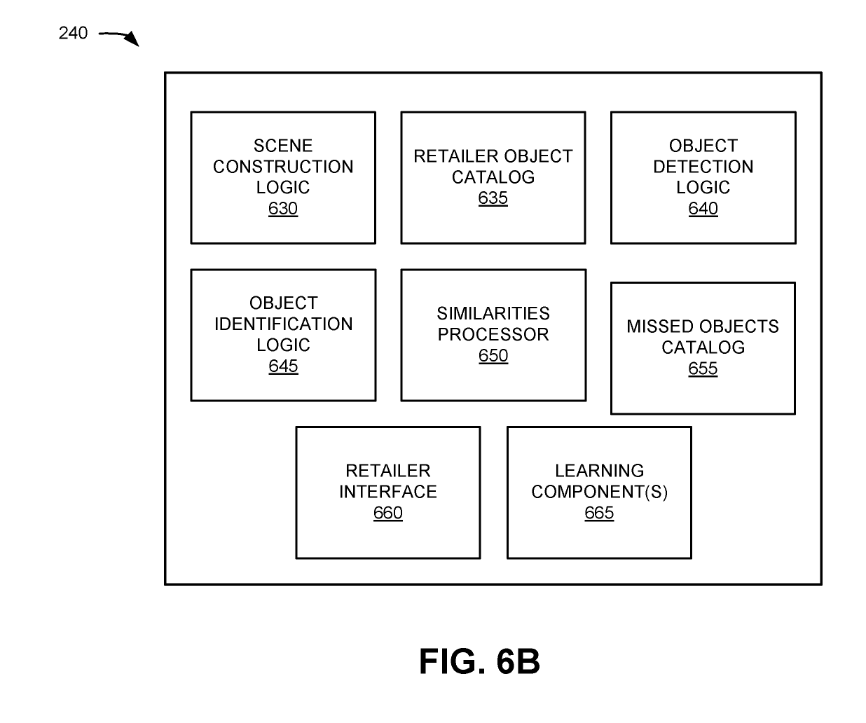

Application platform 230 may include one or more computation, communication, and/or network devices to manage the user experience with smart shopping cart 100. For example, application platform 230 may interface with application 130 to associate a user account with cart 100. Application platform 230 may communicate with cart platform 240 to keep a running list of objects added to (or removed from) cart 100 and to provide the list to application 130 (e.g., from presentation to the user). In one implementation, application platform 230 may also provide prompts and/or suggestions for application 130 to present to a user based on an object identified in cart 100. Additionally, application platform 230 may provide a payment interface to allow a user's account to be billed for identified objects in cart 100 when a shopping event is determined to be complete (e.g., when indicated by a user, or when cart 100 reaches a boundary of the store premises). Application platform 230 is described further herein in connection with, for example, FIG. 6A.

Cart platform 240 may include one or more computation, communication, and/or network devices to receive images from cart 100, perform scene construction from multiple camera angles, identify an in-store location associated with the images, and perform object identification for items in cart 100. Cart platform 240 may associate identified objects with an SKU and provide object descriptions to application platform 230. Cart platform 240 may also include a learning component to improve object identification and may communicate with retailer server 260 to collect product details of items available for purchase in a store. Cart platform 240 is described further herein in connection with, for example, FIG. 6B.

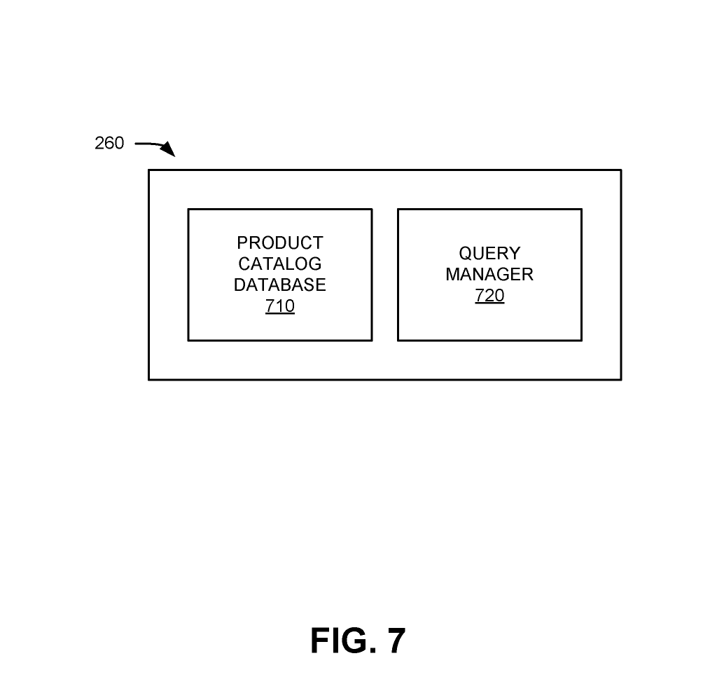

Retailer product cloud 150 may include one or more retailer servers 260. According to one implementation, retailer server 260 may provide cart platform 240 with product information of items in a retail establishment, including, an in-store location (e.g., based on a beacon 225 association), images of physical items, bar codes, SKUs, prices, etc. Additionally, retailer server 260 may respond to inquiries from cart platform 240. Retailer server 260 is described further herein in connection with, for example, FIG. 7.

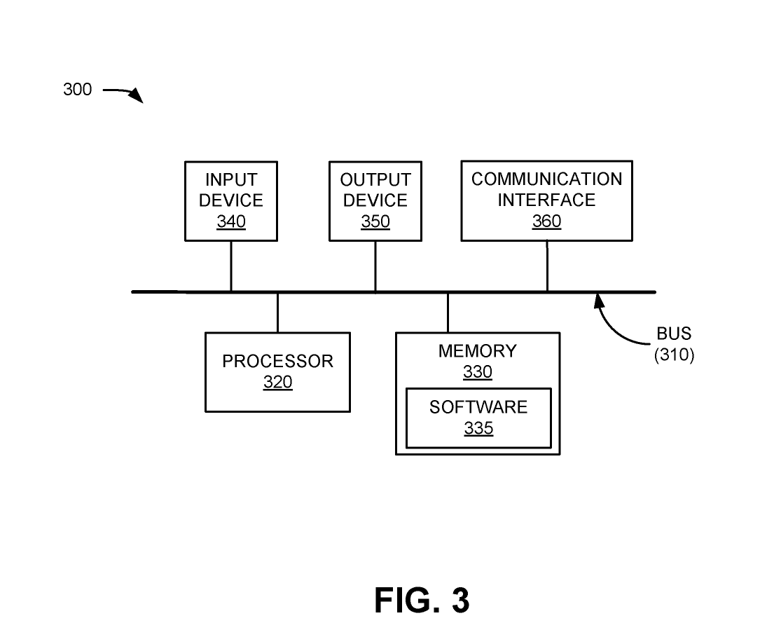

FIG. 3 is a diagram illustrating exemplary physical components of a device 300. Device 300 may correspond to elements depicted in environment 200. Device 300 may include a bus 310, a processor 320, a memory 330 with software 335, an input device 340, an output device 350, and a communication interface 360.

Bus 310 may include a path that permits communication among the components of device 300. Processor 320 may include a processor, a microprocessor, or processing logic that may interpret and execute instructions. Memory 330 may include any type of dynamic storage device that may store information and instructions, for execution by processor 320, and/or any type of non-volatile storage device that may store information for use by processor 320.

Software 335 includes an application or a program that provides a function and/or a process. Software 335 is also intended to include firmware, middleware, microcode, hardware description language (HDL), and/or other form of instruction. By way of example, with respect to the network elements that include logic to provide the object identification services described herein, these network elements may be implemented to include software 335. Additionally, for example, user device 120 may include software 335 (e.g., retailer app 130, etc.) to perform tasks as described herein.

Input device 340 may include a mechanism that permits a user to input information to device 300, such as a keyboard, a keypad, a button, a switch, a display, etc. Output device 350 may include a mechanism that outputs information to the user, such as a display, a speaker, one or more light emitting diodes (LEDs), etc.

Communication interface 360 may include a transceiver that enables device 300 to communicate with other devices and/or systems via wireless communications, wired communications, or a combination of wireless and wired communications. For example, communication interface 360 may include mechanisms for communicating with another device or system via a network. Communication interface 360 may include an antenna assembly for transmission and/or reception of radio frequency (RF) signals. For example, communication interface 360 may include one or more antennas to transmit and/or receive RF signals over the air. Communication interface 360 may, for example, receive RF signals and transmit them over the air to user device 120, and receive RF signals over the air from user device 120. In one implementation, for example, communication interface 360 may communicate with a network and/or devices connected to a network. Alternatively or additionally, communication interface 360 may be a logical component that includes input and output ports, input and output systems, and/or other input and output components that facilitate the transmission of data to other devices.

Device 300 may perform certain operations in response to processor 320 executing software instructions (e.g., software 335) contained in a computer-readable medium, such as memory 330. A computer-readable medium may be defined as a non-transitory memory device. A non-transitory memory device may include memory space within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of or in combination with software instructions to implement processes described herein. Thus, implementations described herein are not limited to any specific combination of hardware circuitry and software.

Device 300 may include fewer components, additional components, different components, and/or differently arranged components than those illustrated in FIG. 3. As an example, in some implementations, a display may not be included in device 300. In these situations, device 300 may be a “headless” device that does not include input device 340 and/or output device 350. As another example, device 300 may include one or more switch fabrics instead of, or in addition to, bus 310. Additionally, or alternatively, one or more components of device 300 may perform one or more tasks described as being performed by one or more other components of device 300.

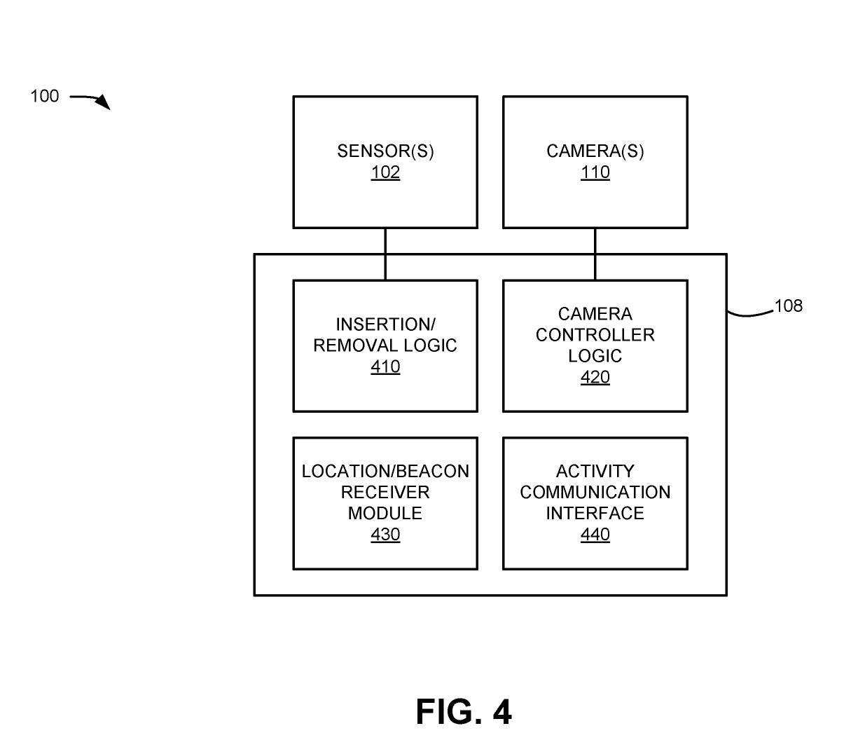

FIG. 4 is a block diagram illustrating exemplary logical aspects of smart shopping cart 100. As shown in FIG. 4, cart 100 may include sensors 102, cameras 110, and computer 108 which may include insertion/removal logic 410, camera controller logic 420, a location/beacon receiver module 430, and an activity communication interface 440. The logical components of FIG. 4 may be implemented, for example, by processor 320 in conjunction with memory 330/software 335.

Insertion/removal logic 410 may communicate with sensors 102 to detect activity that would likely correspond to insertion or removal of an object (e.g., object 10) into or out from cart 100. Sensors 102 may include motion sensors, weight sensors, light sensors, or a combination of sensors to detect physical movement or changes within cart 100. In one implementation, insertion/removal logic 410 may receive input from sensors 102 and determine if activation of cameras 110 is required. In another implementation, insertion/removal logic 410 may use images from cameras 110 to detect activity that would likely correspond to insertion or removal of an object. For example, cameras 110 may continuously collect images from the holding area of cart 110 to identify activity.

Camera controller logic 420 may activate cameras 110 to take pictures (e.g., still pictures or short sequences of video images) based on a signal from insertion/removal logic 410. Thus, the pictures are captured proximate in time to detecting an activity of placing an object into (or removing an object from) cart 100. In one implementation, camera controller logic 420 may cause multiple cameras 110 to take a collection of images simultaneously. In one implementation, images collected by cameras 110 may include a cart identifier, a camera identifier, and a time-stamp. Camera controller logic 420 may compile images from multiple cameras 110 or provide separate images from each camera 110. In another implementation, where cameras 110 continuously collect images, camera controller logic 420 may conserve network resources by operating cameras 110 in one mode to monitor for cart activity and a different mode to capture an insertion/removal event. For example, camera controller logic 420 may cause cameras 110 to operate at low resolution and/or low frame rates when monitoring for activity and may cause cameras 110 to switch to higher resolution and/or higher frame rates when insertion/removal logic 410 actually detects insertion/removal activity.

Location/beacon receiver module 430 may identify a location of cart 100 based on, for example, proximity to a beacon 225, such as a beacon 225 at an aisle entrance/exit within a retail location. For example, location/beacon receiver module 430 may receive signals from beacons 225 via beacon receiver 106. In one implementation, location/beacon receiver module 430 may identify detected beacon signals whenever insertion/removal logic 410 detects cart activity. Thus, location data for cart 100 may be collected and provided to vision service cloud platform 140 proximate in time to detecting an object being inserted into cart 100. The retailer product cloud 150 may supply the vision service cloud platform 140 with a catalog of products located in that beacon transmit area.

Activity communication interface 440 may collect and send activity information to vision service cloud platform 140. For example, activity communication interface 440 may collect images from camera controller logic 420 and beacon information from location/beacon module 430 and provide the combined information to cart platform 240 for object identification. In one implementation, activity communication interface 440 may use dedicated application programming interfaces (APIs) to initiate data transfers with vision service cloud platform 140.

Although FIG. 4 shows exemplary logical components of smart shopping cart 100, in other implementations, smart shopping cart 100 may include fewer logical components, different logical components, or additional logical components than depicted in FIG. 4. For example, in another implementation, smart shopping cart 100 may include additional logic to stitch together images from cameras 110 and add location information. Additionally or alternatively, one or more logical components of smart shopping cart 100 may perform functions described as being performed by one or more other logical components.

FIG. 5 is a block diagram illustrating exemplary logical aspects of user device 120. The logical components of FIG. 5 may be implemented, for example, by processor 320 in conjunction with memory 330/software 335. As shown in FIG. 5, user device 120 may include retailer application 130 with a shopping user interface (UI) 510, a payment UI 520, a cart linker 530, a location system 540, and camera interface 550.

Shopping user interface (UI) 510 may provide information regarding cart 100 to a user of user device 120. In one implementation, shopping UI 510 may communicate with application platform 230 to present cart information to the user. For example, shopping UI 510 may provide a dynamic list of objects detected in shopping cart 100. In one implementation, the dynamic list of objects may include an item description, a price, and/or an SKU for each identified object. According to another implementation, shopping UI 510 may provide a user interface that allows a user to confirm an identified object or the list of all identified objects. Additionally, shopping UI 510 may provide suggestions for items related to identified objects (e.g., as determined by application platform 230). Shopping UI 510 may also solicit information from a user to resolve object identification questions. For example, if vision service cloud platform 140 is unable to identify an object, shopping UI 510 may request clarification from a user. Clarification may include, for example, requesting a user to change orientation of an item in cart 100, providing a list of possible options to be selected by the user, requesting a barcode scan of the item, etc.

Payment user interface 520 may solicit and store payment information to complete purchases of items in cart 100. For example, payment UI 520 may request and store credit card or electronic payment information that can be used to purchase items in cart 100. In one implementation, payment UI 520 may be automatically activated to request or initiate payment when cart 100 and/or user device 120 approaches a store boundary. For example, a geo-fence may be established around a retail establishment, such that when application 130 and/or cart 100 detect(s) exiting the geo-fence boundary, payment UI 520 may automatically initiate payment. In one implementation, payment UI 520 may include prompts to confirm a payment method and initiate a transaction.

Cart linker 530 may include logic to associate application 130 with a particular cart 100. Cart linker 530 may include a bar code reader, quick response (QR) code reader, NFC interface, or other system to identify a unique cart identifier (e.g., cart identifier 104) on cart 100. Cart linker 530 may detect the unique cart identifier 104 and forward cart identifier 104, along with an identifier for user device 120, to application platform 230 so that identified object in cart 100 can be associated with the user of application 130.

Location system 540 may communicate with a GPS or use other location-determining systems (e.g., an indoor location system, etc.) to identify a location of user device 120. In one implementation, location system 540 may provide location information to determine geo-fencing for triggering automatic payments.

Camera interface 550 may activate a camera on user device 120 to take pictures or video of cart 100. For example, camera interface 550 may detect when user device 120 is mounted on docking station of cart 100 and integrate the camera of user device 120 with cameras 110. For example, camera interface 550 may cause user device to collect images based on signals from insertion/removal logic 410. As another example, camera interface 550 may cause user device 120 continuously collect images from the holding area of cart 110. Camera interface 550 may send collected images to application platform 230 (e.g., for forwarding to cart platform 240) or to cart platform 240 directly.

Although FIG. 5 shows exemplary logical components of user device 120, in other implementations, user device 120 may include fewer logical components, different logical components, or additional logical components than depicted in FIG. 5. Additionally or alternatively, one or more logical components of user device 120 may perform functions described as being performed by one or more other logical components.

FIG. 6A is a block diagram of illustrating exemplary logical aspects of application platform 230. The logical components of FIG. 6A may be implemented, for example, by processor 320 in conjunction with memory 330/software 335. As shown in FIG. 6A, application platform 230 may include a cart product list 600, predictive prompts 605, a recommendation engine 610, a payment interface 615, a geo-fencing unit 620, and a user profile database 625.

Cart product list 600 may receive object identification information from carter platform 240, for example, and update a dynamic list of products associated with cart 100. Cart product list 600 may be forwarded to application 130 and stored locally at application platform 230 for managing payments and store inventory.

Predictive prompts 605 may include logic to associate an object in cart 100 with another objet likely to be selected by a user. For example, a customer's placement of salsa into cart 100 may cause predictive prompts 605 to predict tortilla chips might also be desired by the customer. Predictive prompts 605 may provide predictions to retailer app 130 for presentation to a user. In one implementation, predictions may include a product name and its location within the store (e.g., a specific aisle or section). In another implementation, a prediction may include a location where types of suggested products can be found (e.g., a section or a department).

Recommendation engine 610 may include logic that provides recommendations for customer purchases. For example, recommendation engine 610 may recommend products identified in association with a particular user (e.g., based on a user's purchase history in user profile database 625). In some instances, recommendation engine 610 may recommend a group of products based on user profile of a user. Recommendation engine 610 may provide recommendations to retailer app 130 for presentation to a user.

Payment interface 615 may initiate credit card checks and receive credit card verification from an external billing entity, such as a credit card payment system (e.g., for a credit card account associated with the user) or a bank payment system (e.g., for a debit account associated with the user) associated with the user and/or user device 120, via an external payment API (not shown). Payment interface 615 may also initiate payments from retail app 130 to the external billing entity as part of an automated checkout process for cart 100.

Geo-fencing unit 620 may receive (e.g., from Retailer product cloud 150) boundary coordinates (e.g. a geo-fence) associated with a retail establishment where cart 100 is used. Once retail app 130 is associated with cart 100, geo-fencing unit 620 may receive location coordinates from user device 120 to determine when a user exits a retail location or enters a designated checkout area. In response to the detecting, geo-fencing unit 620 may signal payment interface 615 to initiate payment for objects identified in cart 100.

User profile database 625 may include information corresponding to the users of retail app 130, such as user profile information including information, preferences, or policies for payments. By way of example, user profile information may include registration information (e.g., account numbers, usernames, passwords, security questions, monikers, etc.) for retail app 130, system configurations, policies, associated users/devices, etc. In other instances, user profile information also includes historical and/or real-time shopping information relating to the selection of products, brands, tendencies, etc.

FIG. 6B is a block diagram of illustrating exemplary logical aspects of cart platform 240. The logical components of FIG. 6B may be implemented, for example, by processor 320 in conjunction with memory 330/software 335. As shown in FIG. 6B, cart platform 240 may include scene construction logic 630, a retailer object catalog 635, object detection logic 640, object identification logic 645, a similarities processor 650, a missed objects catalog 655, a retailer interface 660, and one or more learning components 665.

Scene construction logic 630 may assemble images of a holding area of cart 100 based one or more images/video received from cameras 110 and/or user device 120. A scene may include a composite view of the holding area formed from multiple images from one or multiple cameras 110 and/or user device 120. The holding area may include, for example, the interior of a basket, storage space under the basket, and/or shelves on cart 100. In one implementation, scene construction logic 630 may examine frame-to-frame changes over time to determine the addition or removal of an item from cart 100.

Retailer object catalog 635 may store product descriptions, images, SKUs, in-store location information, etc., for each retail item at a retail establishment. In one implementation, retailer object catalog 635 may include multiple images of each product (e.g., from different perspectives). Retailer product cloud 150 may provide product information for retailer object catalog 635 and update the product information whenever there are changes to packaging, in-store locations, SKUs, etc.

Object detection logic 640 may detect, based on images from cameras 110 and/or scene construction logic 630, an object that is added to cart 100 or removed from cart 100 (e.g., an object that needs to be identified). For example, object detection logic 640 may isolate an item from images of multiple items and background within cart 100. Conversely, object detection logic 640 may identify that an object is missing from a previous location within cart 100, which may be indicative of removal of the object from cart 100 or a rearranging of items in cart 100.

Object identification logic 645 may process the isolated items from object detection logic 640 looking for matches against product information from retailer object catalog 635. According to an implementation, object identification logic 645 may use a Deep Learning platform that contains several Deep Neural Network (DNN) models capable of recognizing objects. For example, object identification logic 645 may perform various functions to identify an object, including shape recognition, text recognition, logo recognition, color matching, barcode detection, and so forth using one or more DNN models. In one implementation, object identification logic 645 may use location information to work with a subset of potential matching products from retailer object catalog 635. For example, beacon (e.g., beacon 225) signal information from cart 100 may be used to identify an aisle, section, or department of a store where cart 100 is located when an item is placed in to cart 100. Product information of stored retail items assigned to that aisle, section, or department may be processed first for matches with an isolated item in cart 100.

In one implementation, object identification logic 645 may simultaneously apply different models to detect and interpret different features of an object (e.g., object 10), such a shape, text, a logo, colors, and/or a barcode. For shape recognition, object identification logic 645 may compare (e.g., using a DNN) a size and shape of an isolated object to shapes from retailer object catalog 635. For text recognition, object identification logic 645 may apply DNN to natural language processing (NLP) to assemble observable text on packaging. For logo and color recognition, object identification logic 645 may detect color contrasts and compare received images to logos and colors in retailer object catalog 635. In one implementation, object identification logic 645 may also detect barcodes in received images and apply barcode recognition technology to interpret a complete or partial barcode. According to one implementation, object identification logic 645 may assess results from multiple recognition models to determine if an object can be identified with a sufficient level of confidence. Additionally, multiple scenes at different times may be compared (e.g., a frame-by-frame comparison) to determine if a previously added object has been removed or is merely obscured by other objects in cart 100.

Similarities processor 650 may look for near matches to objects in retailer object catalog 635. For example, when an isolated object image cannot be identified, similarities processor 650 may solicit via retail application 130, a user's selection to identify the isolated object image. In one implementation, similarities process 650 may identify retail items (e.g., from retailer object catalog 635) with features similar to those of the isolated object image and allow the user to select (e.g., via retail application 130) the inserted object (e.g., object 10) from a group of possible retail items. Similarities to items in the catalogs may be flagged for future confirmation and learning opportunities Similarities processor 650 may add the isolated object image and the user's selection to a training data set for object identification logic 645. For example, similarities processor 650 may store isolated object images for confirmation by the retailer and eventually feed the associated flagged items back into the aforementioned retailer object catalog 635.

Missed object catalog 655 may collect the output of object identification errors (e.g., object identifications not confirmed by a user of retail app 130 and/or not identified by object identification logic 645) and may generate metadata about the missed objects with their corresponding image sequence. These sequences can be reprocessed or reconciled with a retailer object catalog 635 and used to retune the associated algorithm.

Retailer interface 660 may include a library of designated API calls to provide inquiries to retailer server 260, receive product information updates from retailer server 260, and provide inventory updates based on completed purchases from cart 100.

Learning components 665 may include training data sets for one or more DNN (e.g., for shape recognition, text recognition, logo recognition, color matching, barcode detection, etc.). Training data sets in learning components 665 may be constantly updated using data from retailer catalogs and from user activity with carts 100 based on information from similarities processor 650 and missed object catalog 655.

Although FIGS. 6A and 6B show exemplary logical components in vision service cloud platform 140, in other implementations, vision service cloud platform 140 may include fewer logical components, different logical components, or additional logical components than depicted in FIGS. 6A and 6B. Additionally or alternatively, one or more logical components of vision service cloud platform 140 may perform functions described as being performed by one or more other logical components.

FIG. 7 is a block diagram illustrating exemplary logical aspects of retailer server 260. The logical components of FIG. 7 may be implemented, for example, by processor 320 in conjunction with memory 330/software 335. As shown in FIG. 7, retailer server 260 may include a product catalog database 710 and a query manager 720.

Product catalog database 710 may include product information for retail products at each retail establishment. Product catalog database 710 may store and receive updates from a retailer regarding item descriptions, images, locations, SKUs, and prices. In one implementation, product catalog database 710 may automatically push updated information to cart platform 240. Product catalog database 710 and cart platform 240 may exchange information using, for example, dedicated API calls and responses.

Query manager 720 may assist and/or resolve inquires with object identification. Query manager 720 may receive inquiries for real-time decisions to resolve queries from object identification logic 645, similarities processor 650, and/or retailer interface 660. In one implementation, query manager 720 may provide an interface for a technician (e.g., a human) to provide input to address object identification queries.

Although FIG. 7 shows exemplary logical components of retailer server 260, in other implementations, retailer server 260 may include fewer logical components, different logical components, or additional logical components than depicted in FIG. 7. Additionally or alternatively, one or more logical components of retailer server 260 may perform functions described as being performed by one or more other logical components.

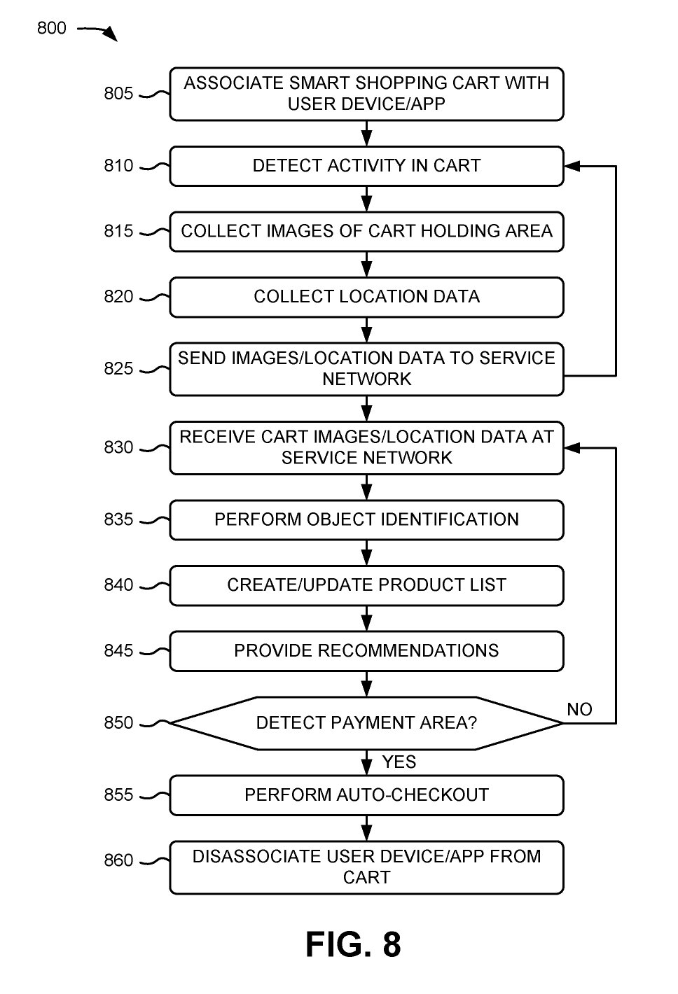

FIG. 8 is a flow diagram illustrating an exemplary process 800 for detecting objects in a retail environment. In one implementation, process 800 may be implemented by cart 100 and vision service cloud platform 140. In another implementation, process 800 may be implemented by vision service cloud platform 140 and other devices in network environment 200.

Process 800 may include associating a smart cart with a user device executing an application (block 805). For example, a user may activate retail application 130 on user device 120 and place user device 120 near cart identifier 104. Retail application 130 may detect cart identifier 104 and send an activation signal to vision service cloud platform 140 to associate retail application 130/the user with cart 100. According to one implementation, upon receiving the activation signal from retail application 130, vision service cloud platform 140 (e.g., application platform 230) may activate sensors 102, cameras 110, and communication interfaces (e.g., activity communication interface 440) to collect and send cart data.

Process 800 may include detecting activity in the cart (block 810), and collecting images of a cart holding area (block 815), collecting location data (block 820), and sending the images and location data to a services network (block 825). For example, sensor 102 of cart 100 may detect placement of an item into a holding area of cart 100, which may trigger cameras 100 to collect images. Alternatively, sensor 102 may detect removal of an item from the holding area of cart 100, which may similarly trigger cameras 100 to collect images. Cart 100 (e.g., location/beacon receiver module 430) may determine a beacon ID or other location data at the time of each image. Activity communication interface 400 may send images from cameras 110 and the location/beacon data to vision service cloud platform 140.

Cart images and location information may be received at a services network (block 830) and object identification may be performed (block 835). For example, cart platform 240 may receive images from cart 100 and process the images to identify objects in cart 100. For example, cart platform 240 may identify each object with sufficient detail to cross-reference the objet to a retailer's SKU associated with the object. Alternatively, cart platform 240 may identify removal of an object from cart 100 based on a frame-to-frame comparison of images from cameras 110 over time.

Process 800 may further include creating or updating a product list (block 840) and providing recommendations (block 845). For example, upon performing a successful object identification, cart platform 240 may inform application platform 230 of the object (e.g., object 10) in cart 100. Application platform 230 may, in response, add the object description to a dynamic list of objects (e.g., cart product list 600) associated with cart 100 and application 130. According to one implementation, application platform 230 may provide the updated list to application 130 for presentation to a user.

Process 800 may further include determining if a user has entered a payment area (block 850). For example, vision service cloud platform 140 may determine that cart 100 has left a shopping area and entered a payment area, which may be inside or outside a retail establishment. In one implementation, cart 100 may detect a beacon (e.g., one of beacons 225) associated with a payment area when cart 100 enters a payment area. Additionally, or alternatively, application 130 may provide location information for user device 120 indicating that a user has entered a geo-fence for a payment area.

If a user has not entered a payment area (block 850-no), process 800 return to process block 830 to continue to receive cart images and location data. If a user has entered a payment area (block 850-yes), process 800 may include performing an automatic checkout procedure and disassociating the user device and application from the cart (block 860). For example, application platform 230 may use payment interface to initiate payment for the objects in cart 100. Upon completion of payment, application platform 230 may signal cart platform 240 that retail application 130 and cart 100 are no longer associated.

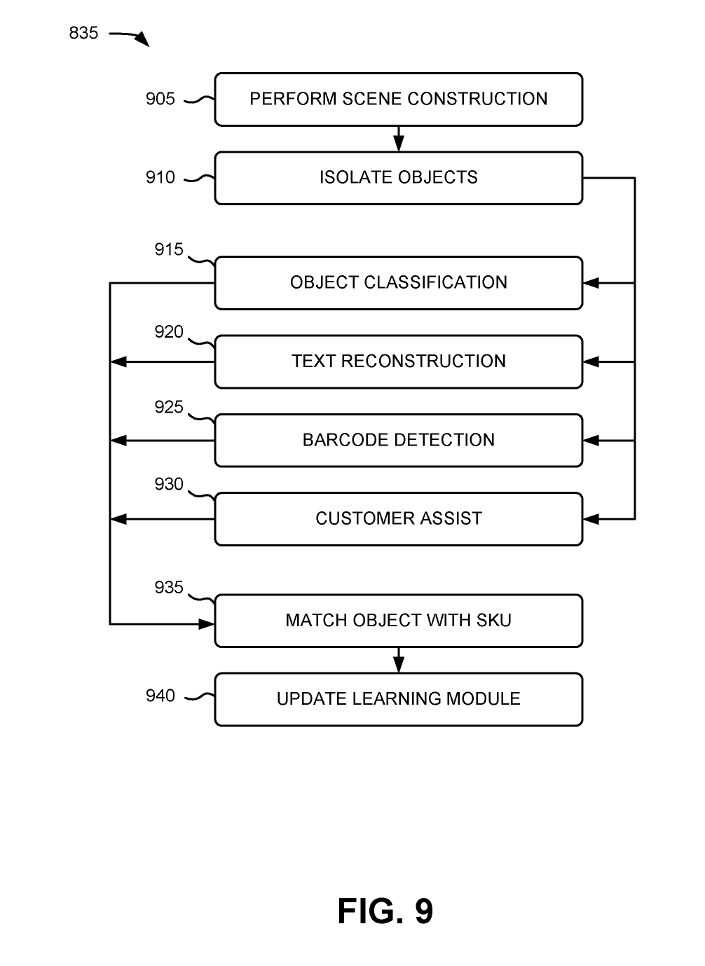

Object identification of process block 835 may include the steps/operations associated with the process blocks of FIG. 9. As shown in FIG. 9, object identification process block 835 may include performing scene construction (block 905) and isolating an object within a scene (block 910). For example, cart platform 240 may stitch together images/views from multiple cameras 110 on cart 100 to construct a complete view of the cart contents and identify objects (e.g., object 10) in cart 100 and removed from cart 100. Cart platform 240 (e.g., object detection logic 640) may apply edge detection techniques or other image processing techniques to isolate individual objects within the images of multiple items and background within cart 100.

Process block 835 may also include performing object classification (block 915), performing text reconstruction (block 920), performing barcode detection (block 925), and/or requesting customer assistance (block 930). For example, process blocks 915 through 930 may be performed sequentially or in parallel. Cart platform 240 (e.g., object identification logic 645) may process the isolated items from object detection logic 640 and identify matches with product information from retailer object catalog 635. Object identification logic 645 may perform shape recognition, text recognition, logo recognition, color matching, barcode detection, and so forth using one or more DNN models. In one implementation, object identification logic 645 may use location information for a beacon 225 to limit product information to a subset of potential matching products from retailer object catalog 635. If an object cannot be identified by cart platform 240, application platform 230 may use retail application 130 to request a user's assistance (e.g., asking a user to scan a barcode, adjust the object in the cart, type a product name, etc.).

Process block 835 may also include matching an object with an SKU (block 935) and updating a learning module (block 940). For example, cart platform 240 may match a logo, name, shape, text, or barcode with a retailer's SKU for an object. Once the object is identified and matched to an SKU, cart platform 240 may update training data sets (e.g., in learning components 665) to improve future performance. Process 900 may also include use of similarities processor 650 and/or missed objects catalog 655, as described herein.

Systems and methods described herein provide a smart shopping cart and supporting network to perform object recognition for items in a retail shopping environment. According to one implementation, network device receives a signal from a user device to associate a portable container with a retail application being executing on the user device. The network device receives, from the container, images of a holding area of the container. The images are captured by different cameras at different positions relative to the holding area and are captured proximate in time to detecting an activity that places an object from the retail establishment into the holding area. The network device generates a scene of the holding area constructed of multiple images from the different cameras and identifies the object as a retail item using the scene. The network device associates the retail item with a SKU and creates a product list that includes an item description for the object associated with the SKU. The product list enables automatic checkout and payment when linked to a user's payment account via the retail application.

The foregoing description of implementations provides illustration and description, but is not intended to be exhaustive or to limit the invention to the precise form disclosed. Modifications and variations are possible in light of the above teachings or may be acquired from practice of the invention. For example, while a series of blocks have been described with regard to FIGS. 8 and 9, the order of the blocks may be modified in other embodiments. Further, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by network device, a signal from a user device, the signal from the user device associating a portable shopping container with a retail application being executing on the user device;
detecting, by the portable shopping container, an activity that places an object from a retail establishment into a holding area of the portable shopping container;
receiving, by the network device, images of the holding area proximate in time to the detecting, wherein the images are captured by different cameras at different positions relative to the holding area;
generating, by the network device, a scene of the holding area constructed from multiple images of the images captured by the different cameras;
identifying, by the network device and using the scene, the object as a retail item;
associating, by the network device, the retail item with a stock-keeping unit (SKU); and
creating, by the network device, a product list that includes an item description for the retail item associated with the SKU.

2. The method of claim 1, wherein the portable shopping container includes one or more sensors that indicate the activity, and wherein the different cameras capture the images in response to the indicating.

3. The method of claim 1, wherein identifying the object as a retail item further comprises:
isolating the object within the scene as an isolated object,
determining that the isolated object cannot be identified as a retail item based on scene,
soliciting, after the determining and via the retail application, a user's selection to identify the isolated object, and
adding the isolated object and the user's selection to a training data set for object identification.

4. The method of claim 1, further comprising:
receiving, by the network device, location data for a location of the portable shopping container proximate in time to the detecting.

5. The method of claim 4, wherein the location data includes a beacon identifier.

6. The method of claim 4, wherein the wherein the identifying further comprises:
selecting a subset of products from a retailer catalog, wherein the subset of products are associated with the location data; and
comparing features of the object with product information, from the catalog, for the subset of products.

7. The method of claim 6, wherein the comparing further includes classifying the object based on one or more of a shape and a color of the object.

8. The method of claim 6, wherein the comparing further includes one or more of:
detecting and interpreting text on the object, or
classifying the object based on one or more of a barcode or a logo on the object.

9. The method of claim 1, wherein the identifying further includes isolating multiple individual objects within the scene.

10. The method of claim 1, further comprising:
detecting, by the portable shopping container, an activity that removes another object from a the holding area of the portable shopping container;
receiving, by the network device, additional images of the holding area proximate in time to the detecting the activity that removes the other object;
detecting, by the network device and based on the additional images, that the other object has been removed from the holding area;
disassociating, by the network device and in response to the detecting that the other object has been removed, the other object from the product list.

11. The method of claim 1, wherein the creating further comprises associating the item description with a retail price.

12. The method of claim 1, further comprising:
receiving, by network device, a signal from the portable shopping container, the signal from the portable shopping container associating the portable shopping container with a checkout area; and
processing payment for the items in the product list after receiving the signal associating the portable shopping container with the checkout area.

13. A system, comprising:
a portable shopping container configured to:
detect an activity that places an object from a retail establishment into a holding area of the portable shopping container, and
collect images of the holding area proximate in time to the detecting the activity, wherein the images are captured by different cameras at different positions relative to the holding area; and
a network device including:
a memory that store instructions, and
one or more processors that execute the instructions to:
receive, a signal from a user device, the signal from the user device associating the portable shopping container with a retail application being executing on the user device,
receive, from the portable shopping container, the images of the holding area,
generating a scene of the holding area constructed from multiple images of the images captured by the different cameras,
identify, using the scene, the object as a retail item,
associate the retail item with a stock-keeping unit (SKU), and
create a product list that includes an item description for the retail item associated with the SKU.

14. The system of claim 13, wherein the one or more processors of the network device are further configured to execute the instructions to:
send, to the retail application, the product list.

15. The system of claim 13, wherein the portable shopping container is further configured to:
determine a beacon identifier for a beacon associated with a location in the retail establishment, and
send, to the network device, the beacon identifier with the images.

16. The system of claim 13, wherein the one or more processors of the network device are further configured to execute the instructions to:
receive a signal from the portable shopping container, the signal from the portable shopping container associating the portable shopping container with a checkout area; and
process a payment for the retail item in the product list after receiving the signal associating the portable shopping container with the checkout area.

17. The system of claim 16, wherein the signal associating the portable shopping container with the checkout area includes a beacon identifier.

18. A non-transitory computer-readable medium containing instructions executable by at least one processor, the computer-readable medium comprising one or more instructions to cause the at least one processor to:
receive a signal from a user device, the signal from the user device associating a portable shopping container with a retail application being executing on the user device;
receive, from the portable shopping container, images of a holding area of the portable shopping container, wherein the images are captured by different cameras at different positions relative to the holding area, and wherein the images are captured proximate in time to detecting an activity that places an object from a retail establishment into the holding area;
generate a scene of the holding area constructed from multiple images of the images captured by the different cameras;
identify, using the scene, the object as a retail item;
associate, based on the images, the retail item with a stock-keeping unit (SKU); and
create a product list that includes an item description for the retail item associated with the SKU.

19. The non-transitory computer-readable medium claim 18, further comprising one or more instructions to:
isolate individual objects within the scene.

20. The non-transitory computer-readable medium claim 18, further comprising one or more instructions to:
automatically initiate a payment for the retail item associated with the SKU when the portable shopping container enters a checkout area.
